(19) United States
(12) Patent Application Publication
(10) Pub. No.: US 2026/0261219 A1
(43) Pub. Date: Sep. 3, 2026

(54) PIEZOELECTRIC INERTIA DRIVE

(71) Applicant: PHYSIK INSTRUMENTE (PI) GMBH & CO. KG, Karlsruhe (DE)

(72) Inventor: Alexej WISCHNEWSKI, Worth (DE)

(21) Appl. No.: 18/869,632

(22) PCT Filed: May 26, 2023
(86) PCT No.: PCT/DE2023/100399

§ 371 Date: Nov. 26, 2024

(30) Foreign Application Priority Data
May 27, 2022 (DE) 10 2022 113 382.6

(51) Int. Cl. H02N 2/10; H02N 2/04; H02N 2/14

(52) U.S. Cl. CPC H02N 2/101; H02N 2/046; H02N 2/14

(57) ABSTRACT

The invention relates to a piezoelectric inertia drive (1) comprising: a drive device (2) having a drive element (5) which comprises contact elements (9, 10) having an inner peripheral surface (4) that has a thread (3); an element (6) to be driven having an outer peripheral surface (8) provided with a thread (7); and an electric excitation device (16) for electrically controlling the drive device (2), wherein the element (6) to be driven is in threaded engagement with the drive elements (5). The contact elements (9, 10) are positioned symmetrically with respect to a virtual diametrical separating plane (P) and engage around at least part of the element (6) to be driven, wherein the contact elements (9, 10) are directly or indirectly connected to a base element (14) and to one another, and the drive device (2) has at least two multilayer piezoelectric actuators (11) which have a virtual actuator longitudinal axis (19) and which are positioned with a first side (12) on the base element (14) and with another side (13) that is opposite the first side (12) on the contact element (9, 10), and the electric excitation device (16) contains at least two generators (17, 18) which provide electrical voltages for exciting the piezoelectric actuators (11).

The invention relates to a piezoelectric inertia drive.

Piezoelectric inertia drives are known from the prior art, in which the friction contact is designed in the form of a threaded engagement. They can be used, for example, as spindle drives in various types of mechanisms, such as in linear drives, in precise closure and metering systems, in valves, in precise cutting drives, in control drives, in precise positioning devices, such as in technological coordinate tables, in multi-coordinate positioning devices, in tripods or hexapods, in optical laser systems and similar devices, and in precision medical devices, e.g. pumps, syringes, insulin pumps or devices for bone lengthening.

Lasers are used in many areas of technology, be it in metrology, medical technology, metal processing, etc. The laser beam is usually precisely directed or guided with the help of tilting mirrors. The required precision of laser beam steering is achieved with the help of micrometer screws. These are often operated manually. However, there are a number of applications in which manual adjustment of the tilting mirrors is not possible or undesirable, for example within a vacuum chamber, in a lithography machine or in a tachymeter. Piezoelectric drive devices based on inertia are often used for automatic positioning of the tilting mirrors.

Piezoelectric drive devices based on inertia are often used for automatic positioning of the tilting mirrors. In an inertia drive, an element to be driven, ie the rotor or rotor, is connected or coupled to a piezoelectric actuator via a friction contact. The movement sequence of such inertial drives consists of two phases: in the first phase, the piezo actuator is slowly expanded and transfers the corresponding movement to the element to be driven due to static friction. In the second and first phases there is a rapid phase Contraction of the actuator takes place. Due to its inertia, the element to be driven cannot follow the fast movement of the actuator and remains in its position. This results in a relative movement (sliding) between the actuator and the element to be driven, ie the actuator slips and sliding friction prevails in the friction contact. Of course, it is possible to swap the timing of the two previously mentioned phases, so that in the first phase there is a rapid expansion with a relative movement or sliding between the actuator and the element to be driven without a drive movement, and in the second phase there is a slow contraction of the Actuator takes place, in which the element to be driven is carried along due to static friction and thus a corresponding drive movement takes place.

The applicant's DE 102021 113 751 A1 describes a drive device for driving a spindle, which comprises two actuator devices, the actuator devices acting on an actuating device and a frame device and via corresponding contact surface sections which make contact with the spindle at two different Contact points are provided, a drive of the spindle is realized.

The publication US 2011/0 109 197 A1 discloses a drive device with a drive shaft which is surrounded by a rotatably mounted drive element, with several contact elements evenly distributed over the circumference being pressed onto the drive shaft. The drive element is set into a rotational movement via two actuators arranged diametrically opposite each other, which carry out a drive movement in the same direction, which is transmitted to the drive shaft via the contact elements. Due to the application of a sawtooth voltage to the actuators, a stick-slip drive method results, with which a continuous rotational movement of the drive shaft can be achieved.

EP 1 396 012 B2 teaches a piezoelectric drive with a piezo element that is coupled to a resonator with a horn, with vibrations from the piezo element suitable for driving the resonator and in particular the horn are transmitted, which in turn can be pressed against the surface of an element to be driven, and the vibrations of the horn lead to a drive of the element to be driven.

DE 102010 022 812 B4 describes an ultrasonic motor with an annular ultrasonic actuator for generating a traveling wave, which is transmitted to a contact element arranged on the inner circumference of the ultrasonic actuator, which is in threaded engagement with a threaded rod to be driven, and thus results in a rotational movement of the threaded rod.

The publication DE 199 09 913 A1 discloses an electromechanical drive device with a rotor mounted and driven in a bearing device and a piezo element, the bearing device having a rotor receptacle which can be driven by the piezo element.

A piezoelectric inertia drive for rotationally driving an element to be driven in the form of a spindle is known from U.S. Pat. No. 5,410,206 A. Here, the spindle is gripped on both sides using a piezoelectrically driven drive device in the form of two threaded clamping jaws and is in frictional contact with them. One of the two clamping jaws is connected to a piezo actuator, which sets the threaded rod in motion or rotation based on the principle of inertia. The second clamping jaw presses the threaded rod against the first clamping jaw and thereby supports the threaded rod.

The main disadvantage of the spindle drive of U.S. Pat. No. 5,410,206 A is that the drive movement is different for the two directions of rotation of the spindle, since the piezoelectric actuator behaves differently with regard to expansion and compression. The drive therefore has different properties in the two drive directions, so that different step sizes and travel speeds result in the different directions of rotation of the spindle. In order to linearize the drive characteristics, special control measures are required in the control electronics. Another disadvantage is that the second clamping jaw brakes the spindle, which results in reduced efficiency of the drive device.

The object of the invention is therefore to provide a piezoelectric inertia drive, in particular for driving a spindle, which has symmetrical drive properties and thus, in the case of a spindle as the element to be driven, drives it in the same way and preferably identically in both directions of rotation or rotation, and which also has a high level of efficiency, so that reduced control power is possible.

This object is achieved by a piezoelectric inertia drive according to claim 1, the subsequent subclaims describing at least useful developments.

If the indefinite article is used for a feature in the text—as above and possibly also below—then when the same feature is subsequently mentioned by using the definite article, explicit reference is made to the quantity information implied by the indefinite article, without this this should lead to a corresponding restriction to precisely this quantity.

The piezoelectric inertia drive according to the invention comprises a drive device with a drive element which has contact elements and each of the contact elements has an inner circumferential surface having a thread. The piezoelectric inertia drive according to the invention further comprises an element to be driven with a threaded outer peripheral surface, as well as an electrical excitation device for electrically controlling the drive device, the element to be driven being in threaded engagement with the drive element.

The contact elements are arranged symmetrically with respect to a virtual diametrical parting plane (P) and at least partially surround the element to be driven, with the contact elements directly or are indirectly connected to a base element and additionally to one another, and the drive device has at least two piezoelectric and preferably multilayer actuators with a virtual actuator longitudinal axis, which have a respective first side on the base element and a respective other side opposite the first side on the respective contact element are arranged, and the electrical excitation device contains at least two generators which provide electrical voltages for exciting the piezoelectric actuators.

Due to the symmetrical arrangement of the contact elements or the piezoelectric actuators, a symmetrical and similar drive of the drive element or the contact elements is achieved, whereby a substantially equal speed and a substantially equal step size of the element to be driven in both directions of rotation or rotation is achieved. The contact elements not only support or support the element to be driven, but are both involved in driving or propelling the element to be driven. Thus, none of the contact elements brakes the element to be driven, so that the efficiency of the piezoelectric inertia drive according to the invention is correspondingly high.

According to the invention, the contact elements of the drive element are connected to one another via an elastic element and to two or four elastic elements of carriers of the base element by means of connecting elements, the piezoelectric actuators being biased by the elastic elements of carriers of the base element in the axial direction by means of the connecting elements. The elastic element for connecting the contact elements of the drive element enables the formation of a torque acting on the element to be driven when the piezoelectric actuators are controlled and deformed accordingly. The elastic elements of supports of the base element enable the piezoelectric actuators to be pretensioned in the axial direction using the connecting elements. In the presence of four elastic elements of the supports, one results Symmetrical construction that counteracts or compensates for any bending of the supports.

It can be advantageous that each virtual actuator longitudinal axis is arranged parallel to the virtual diametrical separation plane (P). This allows the force acting on the contact elements to be maximized.

It can also be advantageous that the piezoelectric inertia drive has elastic elements which are connected to the base element and through which the contact elements are pressed against the element to be driven. By connecting the elastic elements to the base element, a leverage effect and the creation of a torque on the element to be driven are achieved. Furthermore, the connection of the elastic elements to the base element absorbs possible adverse external forces acting perpendicular to the longitudinal axis of the actuator.

It can also be advantageous that the drive device comprises an elastic element through which the contact elements are pressed against the element to be driven. Such an elastic element can be used to apply a force acting perpendicular to the longitudinal axis of the element to be driven, which presses the contact elements onto the element to be driven.

It can also be advantageous that the base element has two movable elements and two elastic elements, through which the contact elements are pressed against the element to be driven

Furthermore, it can be advantageous for the drive element to have an elastic element through which the corresponding piezoelectric actuator is biased in the axial direction. It can be of particular advantage here that the drive element additionally has a connecting element through which the corresponding piezoelectric actuator is pre-stressed in interaction with the elastic element, whereby an increased pre-stress is possible.

Piezoelectric multilayer actuators in particular require an axial preload force to ensure that the layers do not delaminate. The invention also relates to a drive device with a drive element, which comprises contact elements with an inner circumferential surface having a thread, an element to be driven with an outer circumferential surface provided with a thread, and an electrical excitation device for electrically controlling the drive device, the element to be driven having the Drive elements are in threaded engagement, and the contact elements are arranged symmetrically with respect to a virtual diametrical parting plane and at least partially encompass the element to be driven, the contact elements being directly or indirectly connected to a base element, and the drive device having at least two multi-layer piezoelectric actuators with a virtual actuator longitudinal axis which are arranged with a respective first side on the base element and with a respective other side opposite the first side on the respective contact element, and the electrical excitation device contains at least two generators which provide electrical voltages for exciting the piezoelectric actuators, wherein the Drive element is designed as a two-part element and is connected by means of connecting elements to two or four elastic elements of supports of the base element, and the piezoelectric actuators are biased in the axial direction by the elastic elements by means of the connecting elements. With such a drive device, a larger feed amplitude of the element to be driven can be achieved.

It can be advantageous that the element to be driven is designed as a hollow threaded rod and the corresponding cavity is filled with a sound-absorbing material. This makes it possible to reduce any parasitic vibrations that may arise in the element to be driven, thereby improving the drive function of the piezoelectric inertia drive.

Furthermore, it can be advantageous for the thread of the element to be driven or the thread of the contact elements to be made of an abrasion-resistant material or with an abrasion-resistant layer is provided, resulting in less wear and an extended service life. It is also conceivable that the element to be driven or the contact elements is or are made of an abrasion-resistant material.

It may prove to be advantageous for the piezoelectric inertia drive to have a pressing device with which the element to be driven is pressed against the drive element and which acts directly or indirectly on the element to be driven in the axial direction. This results in a higher contact force, which results in a greater torque of the piezoelectric inertia drive.

In addition, it can prove to be advantageous for the piezoelectric inertia drive to have two or more than two drive devices which act on a common element to be driven, the drive devices being fixed relative to one another by elastic elements. By using multiple drive devices, the driving force of the piezoelectric inertia drive is increased. The elastic elements prevent movement of the drive devices in the direction pointing towards one another, but enable movements in other degrees of freedom. This prevents the element to be driven from jamming, especially if it is in the form of a threaded rod or a spindle.

In addition, it may prove advantageous for the electrical excitation device to be designed to generate two complementary sawtooth-shaped electrical voltages U1, U2 in order to excite the piezoelectric actuators. This leads to particularly effective operation of the piezoelectric inertia drive.

Advantages and expediencies of the invention become clearer from the following description of preferred exemplary embodiments based on the figures. Show it:

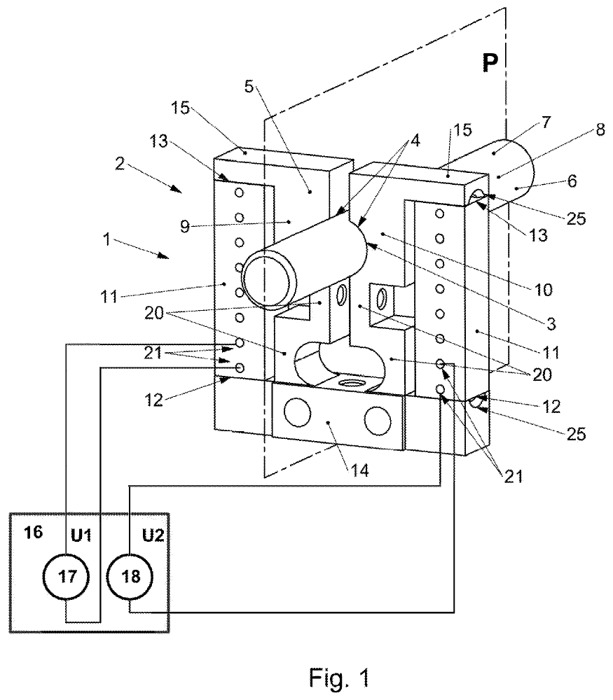

FIG. 1: Perspective view of a piezoelectric inertia drive that is not part of the invention.

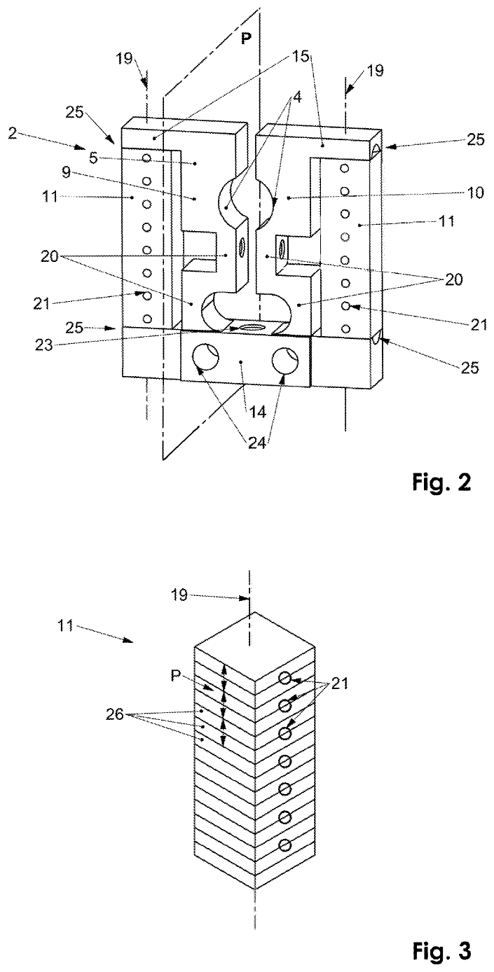

FIG. 2: Perspective view of the drive device of the piezoelectric inertia drive according to FIG. 1.

FIG. 3: Perspective view of a multi-layer actuator for a piezoelectric inertia drive according to the invention.

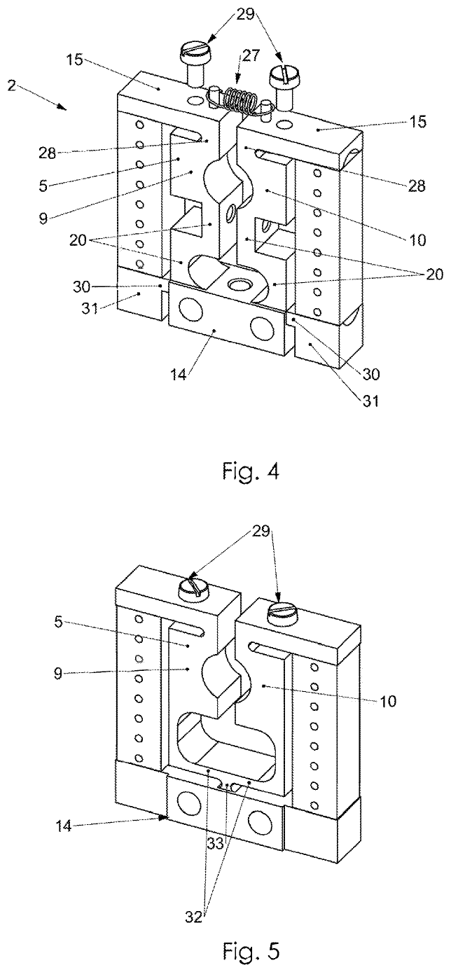

FIG. 4: Perspective view of a drive device that is not part of the invention.

FIG. 5: Perspective view of a drive device that is not part of the invention.

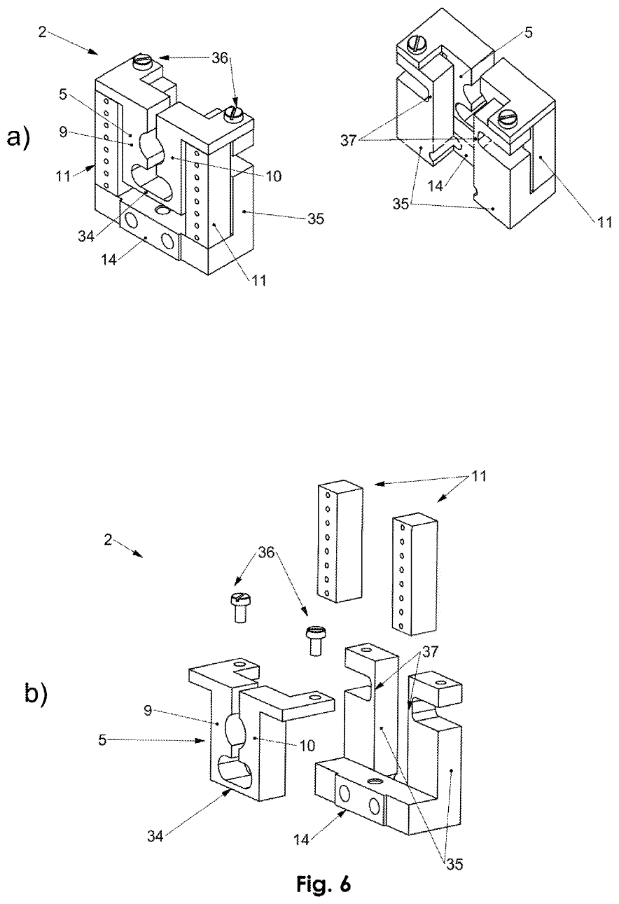

FIG. 6a): Two different perspective views of an embodiment of a drive device of a piezoelectric inertia drive according to the invention; FIG. 6b): Exploded view of the drive device according to FIG. 6a).

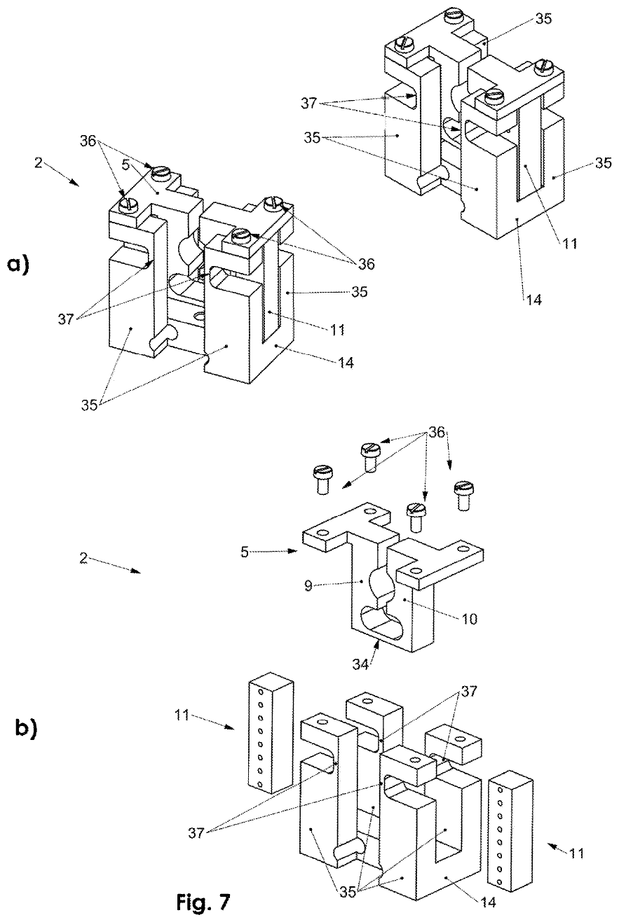

FIG. 7a): Two different perspective views of a further embodiment of a drive device of a piezoelectric inertia drive according to the invention; FIG. 7b): Exploded view of the drive device according to FIG. 7a).

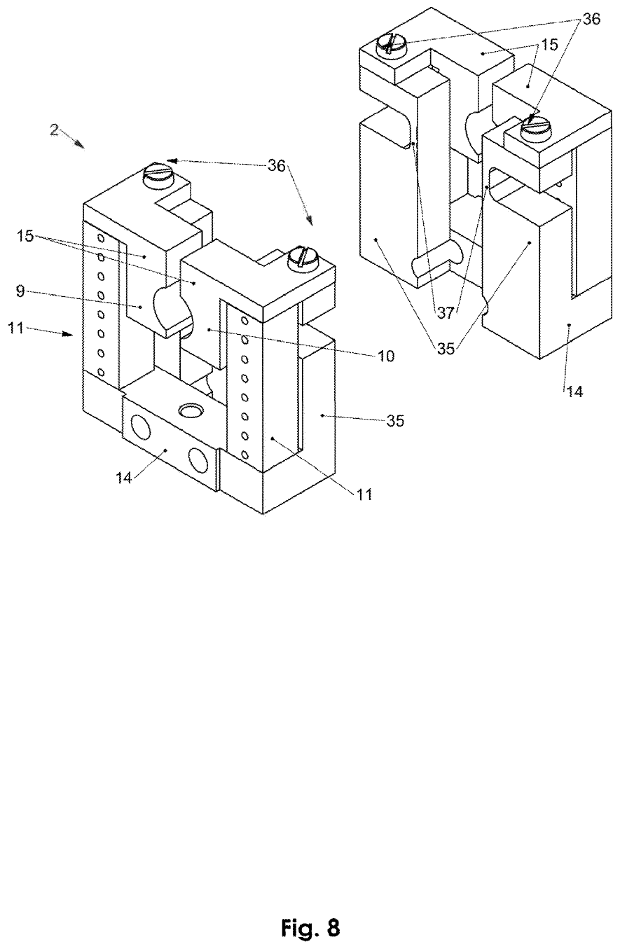

FIG. 8: Two different perspective views of a further embodiment of a drive device of a piezoelectric inertia drive according to the invention.

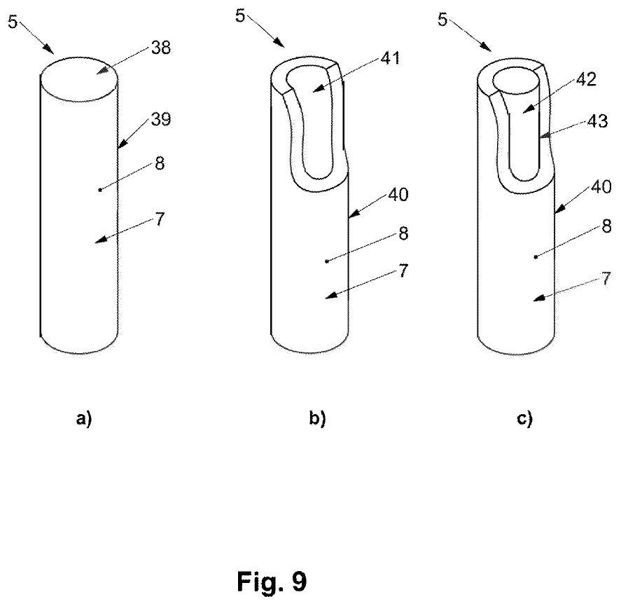

FIG. 9a)-c): Different embodiments for an element to be driven of an inertia drive according to the invention in the form of a threaded rod.

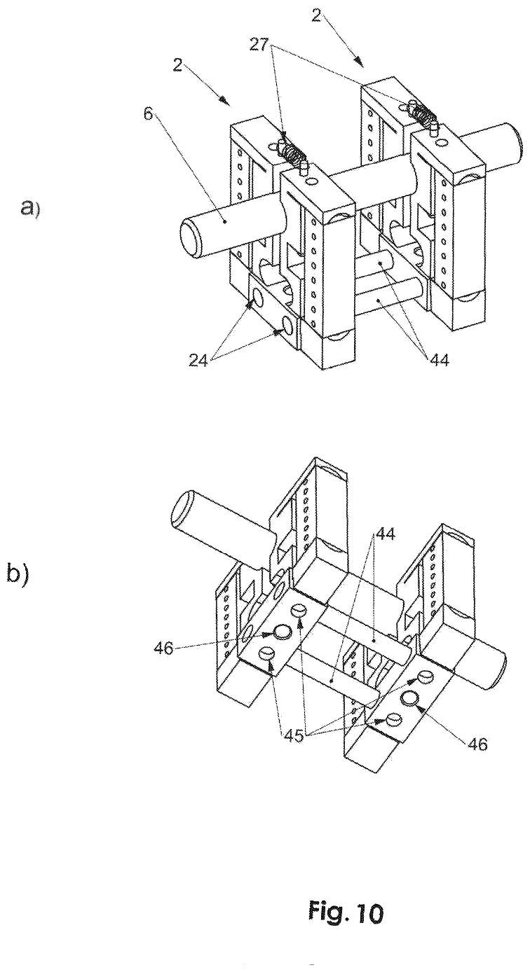

FIGS. 10a), 10b): Different perspective representations of a piezoelectric drive with two drive devices that are not part of the invention and a common element to be driven.

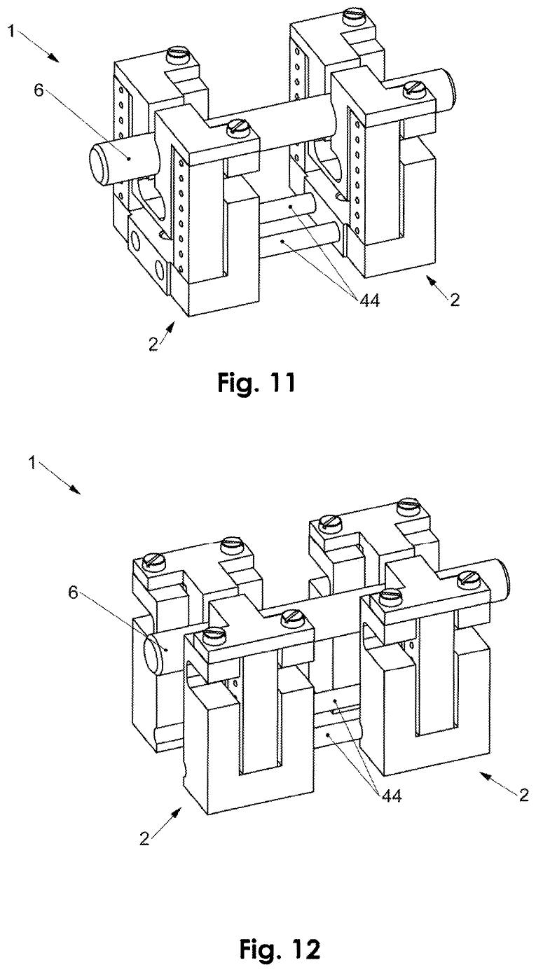

FIGS. 11, 12: Different embodiments for a piezoelectric drive according to the invention with two drive devices and a common element to be driven.

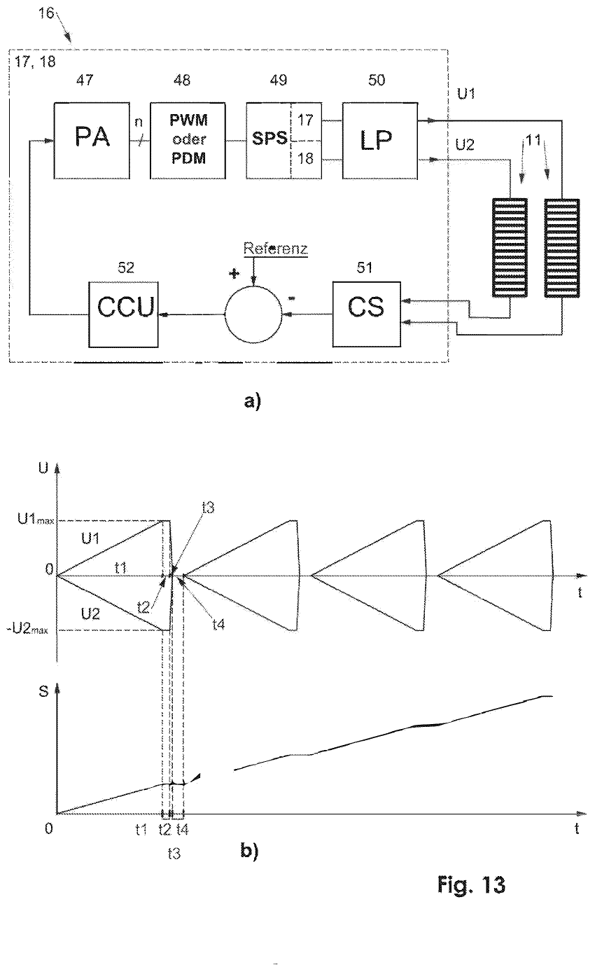

FIG. 13a): Basic structure of an electrical excitation device of a piezoelectric inertia drive according to the invention; FIG. 13b): Representation of the time course of the electrical voltages generated by the excitation device according to FIG. 13a) and the resulting movement of the element to be driven.

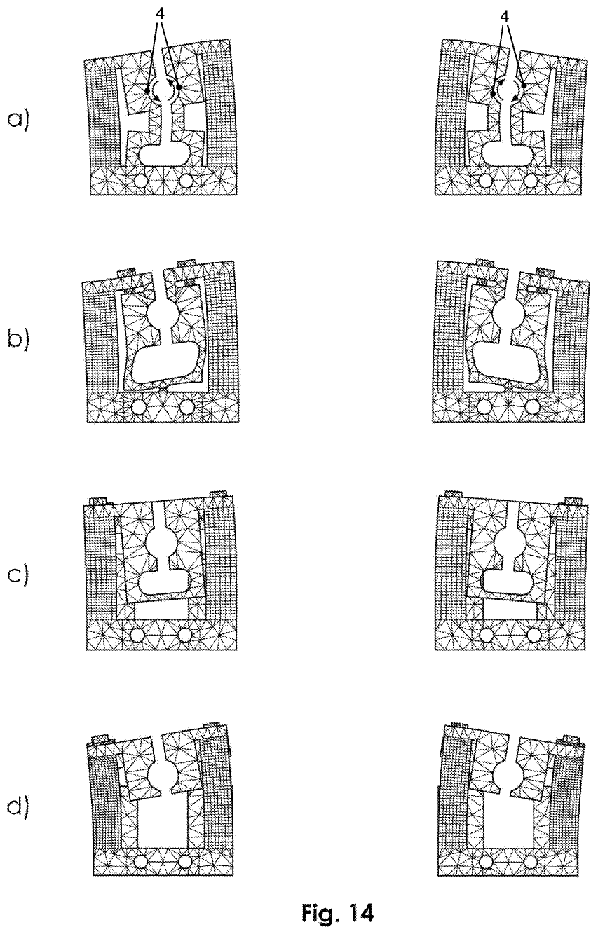

FIG. 14a)-d): Maximum deformations of the drive device according to FIGS. 2, 5, 6 and 8 calculated using the finite element method (FEM) when controlling the actuators for generating a drive movement of an element to be driven in or counterclockwise.

The piezoelectric inertia drive 1 shown in FIG. 1 and not part of the invention has a threaded element 6 to be driven in the form of a spindle and an electrical excitation device 16. The inertial drive 1 includes a drive device 2 driven by two multilayer piezoelectric actuators 11. The drive device is divided by a virtual diametrical plane P, which runs through the center or the axis of the element 6 to be driven.

The drive device 2 has a drive element 5 with two contact elements 9 and 10 arranged symmetrically with respect to the diametrical plane P, which are formed integrally or in one piece with the anti-rbs element 5. Each of the contact elements 9, 10 has a threaded inner peripheral surface 4. The two contact elements 9, 10 grasp or contact the element 6 to be driven from two sides, and this is in a thread friction engagement with the two contact elements 9, 10. Each of the piezoelectric actuators 11 is supported on a base element 14 with one side 12. The other and opposite side 13 of the corresponding piezoelectric actuator 11 is connected to the respective contact element 9, 10 of the drive element 5. It is conceivable that the piezoelectric actuators 11 are fixed with the side 12 to the base element 14 by gluing. Each of the contact elements 9, 10 has two elastic sections 20.

The excitation device 16 contains two electrical generators 17, 18, which generate complementary electrical sawtooth-like voltages U1, U2. The excitation device 16 is with the piezoelectric actuators 11 electrically connected via electrical connections 21 provided on the actuators. By controlling the actuators of the drive device with the electrical excitation device 16, the thing to be driven Element 6 is placed directly in a rotational and indirectly in a translational movement. The element 6 to be driven can be equipped with adhesive pockets 12 for filling an adhesive in order to additionally fix the piezoelectric actuators 11.

FIG. 2 shows an individual representation of the drive device 2 of the piezoelectric inertia drive 1 according to FIG divided into two equal symmetrical halves. The contact elements 9, 10, which are integrally formed with the drive element 5, each have an inner circumferential surface 4 provided with a thread. The piezoelectric actuators are supported on one side 12 on the base element 14 of the drive element 5 and on the other opposite side they are connected to the drive element 5. The support points are located between the two actuators. Their virtual longitudinal axes 19 run parallel to the virtual diametrical plane P. The piezoelectric actuators have electrical connections 21. A fastening hole 23 is used to screw the drive device 2 onto a base body or a device housing. The fastening holes 24 serve to fix elastic elements not shown in FIG. 2. Furthermore, the drive element 5 has four elastic sections 20. The elastic sections enable the contact elements 9, 10 to be pressed against the element 6 to be driven. An optional elastic element 27 in the form of a spiral spring can be placed in the bore 22, which pulls the contact elements 9, 10 together or towards one another and thus attracts them presses the element to be driven.

FIG. 3 shows a multilayer piezoelectric actuator 11 for use in a piezoelectric inertia drive according to the invention. The individual actuator layers 26 each have electrodes on their large surfaces and piezoelectric material arranged between them. All adjacent layers 26 have an opposite electrical direction, indicated by the arrows P Polarization on. Electrodes of the same polarity are connected to one another and are connected to the electrical connections 21.

FIG. 4 shows a drive device 2 of an inertia drive, which is not part of the invention. In this embodiment variant of the drive device 2, both contact elements 9, 10 of the drive element 5 are connected by an elastic element in the form of a spiral spring 27 and are thus pressed against the driven element 6. Other shapes for the elastic element are conceivable, for example in the form of a flat spring. The drive element 5 of the embodiment variant shown in FIG. 4 also has elastic elements 30 and movable elements 31 which press the contact elements 9, 10 onto the element to be driven. In addition, each of the contact elements 9, 10 has an elastic element 28. The elastic elements 28 enable the piezoelectric actuators to be biased in the axial direction. An additional preload force is achieved with the help of the connecting elements 29 in the form of screws.

FIG. 5 shows a further drive device 2 of an inertia drive 1, which is not part of the invention. In this embodiment variant of the drive device 2, both contact elements 9, 10 of the drive element 5 each have an elastic element 32. The elastic elements 32 are connected to the elastic element 33. The elastic elements 32 and 33 enable the contact elements 9, 10 to be pressed onto the element to be driven. The contact elements 9, 10 are connected to the base section 14 via the elastic elements 32 and 33.

FIG. 6a) shows two different perspective views of an embodiment of a drive device 2 of a piezoelectric inertia drive 1 according to the invention. The contact elements 9, 10 of the drive element 5 are connected to one another via an elastic element 34. The base element 14 has two supports 35, via which the drive element 5 is connected to the base element 14 by means of the connecting elements 36. The carriers 35 have elastic sections 37, which preload the piezoelectric actuators 11 axial direction or along their virtual longitudinal axis. FIG. 6b) shows the drive device 2 according to FIG. 6a) in a corresponding exploded view.

FIG. 7a) shows two different perspective views of a further embodiment of a drive device 2 of a piezoelectric inertia drive 1 according to the invention. Here, the contact elements 9, 10 of the drive element 5 are connected to one another via an elastic element 34. The base element 14 has four supports 35 on, via which the drive element 5 by means of the connecting elements 36 is connected to the base element 14. The carriers 35 have elastic sections 37 which enable the piezoelectric actuators 11 to be pretensioned in the axial direction. FIG. 7b) shows the drive device 2 according to FIG. 7a) in a corresponding exploded view.

FIG. 8 shows two different perspective views of an alternative embodiment of a drive device 2 of a piezoelectric inertia drive 1 according to the invention. Here, the drive device 2 has a two-part drive element 15. The contact elements 9, 10 of the drive element 15 are not connected to one another. The base element 14 has two supports 35, via which the drive element 15 is connected to the base element 14 by means of the connecting elements 36. The carriers 35 have elastic sections 37 which enable the piezoelectric actuators 11 to be pretensioned in the axial direction.

FIG. 9a) to 9c) show different embodiments for an element 6 to be driven of an inertia drive 1 according to the invention in the form of a threaded rod. According to FIG. 9a), the element 6 to be driven is designed as a fully threaded rod 38 made of a hard and abrasion-resistant material, such as heat-treated steel, oxide or metal ceramic. Furthermore, according to FIG. 9b) or FIG. 9c), it is possible to design the element 6 to be driven as a hollow threaded rod 40, with the corresponding inner opening 41 having a round shape. However, other geometries of the inner opening are also conceivable, such as one polygonal shape. A rod 42 made of sound-absorbing material can be inserted into the opening 41 of the hollow threaded rod 40 according to FIG. 9c). This rod 42 is made of an elastic material such as. B. made of rubber. The elastic material can be filled with hard particles such as B. be filled with metal particles. In addition, it is also conceivable that the rod 42 is made of a viscoelastic material, e.g. B. a thermoplastic material, the viscoelastic material containing particles, e.g. B. can be filled with metal and/or rubber particles. Furthermore, the rod 36 can also be made of a hard porous material, such as. B. made of porous oxide ceramic, the pores of which are filled with a viscous material. A variety of other materials or material mixtures with a high sound absorption factor for the rod 42 are conceivable. The rod 42 can, for example, also be made of a hard material such as steel, oxide ceramic, metal ceramic, with a layer of sound-absorbing material 43 (e.g. rubber, epoxy resin or similar) being arranged between the rod 42 and the drive element 5.

FIGS. 10a) and 10b) show different perspective views of a piezoelectric inertia drive 1, which is not part of the invention, with two drive devices 2 according to FIGS. 2, 4 and 5 and a common element 6 to be driven. The drive devices 2 are driven using elastic elements 44 kept at a distance from each other. The elastic elements 44 are fixed to the base element 14 with the help of fastening elements in the form of grub screws screwed into the bores 45. It is also conceivable to fix the drive devices 2 against one another using flat elastic elements in the form of leaf springs. The fastening hole 46 is used to fasten the piezoelectric inertia drive to a base body or device housing. It is conceivable to use three or more drive devices 2 instead of the two drive devices shown here.

FIG. 11 shows an embodiment of a piezoelectric inertia drive 1 according to the invention with two drive devices 2 according to FIG. 6 and a common element 6 to be driven. The drive devices 2 are kept at a distance from one another with the aid of elastic elements 44. The elastic elements are fixed to the base element 14 with the help of fastening elements in the form of grub screws screwed into the holes 46. It is conceivable to use three or more drive devices 2 instead of the two drive devices shown here.

FIG. 12 shows a further embodiment for a piezoelectric inertia drive 1 according to the invention with two drive devices 2 according to FIG. 7 and a common element 6 to be driven. The drive devices 2 are kept at a distance from one another with the aid of elastic elements 44. The elastic elements are fixed to the base element 14 with the help of fastening elements in the form of grub screws screwed into the holes 46. It is conceivable to use three or more drive devices instead of the two drive devices shown here.

FIG. 13a) illustrates the basic structure of an electrical excitation device of a piezoelectric inertia drive according to the invention. The excitation device can be constructed in a microcontroller, in an FPGA or from discrete integral circuits. The excitation device includes a phase accumulator (PA) 47, a pulse width modulator or pulse density modulator (PWM or PDM) 48, a switched power output stage (SPS) 49, a low-pass filter (LP) 50, a current sensor 51 and a current control unit 52.

The phase accumulator 47 represents an incrementing or decrementing n-bit register that generates a linearly increasing or decreasing binary number. The PWM or PDM 48 modulates the pulse width or pulse density of a high-frequency square-wave carrier signal according to the binary number (ramp function) generated by the PA 47. The frequency fcar of the carrier signal is preferably 10 times with respect to the frequency fexc at which the piezoelectric actuators are excited higher. The ramp function-modulated square-wave carrier voltage is further amplified by the PLC 49 and passed on to the piezoelectric actuators 11 via the LP (50). The generators 17, 18 are two transistor bridge or half-bridge circuits within the switched power output stage 49. The electrical current of the actuators 11 is measured by the current sensor (CS) 51, compared with a reference signal and forwarded to the current control unit (CUU) 52. The current control unit (CCU) 52 regulates the electrical current corresponding to the predetermined reference signal and thus influences the expansion of the piezoelectric actuators.

FIG. 13b corresponds to a representation of the time course of the electrical voltages U1, U2 generated by the excitation device 16 according to FIG. 13a and the movement S of the element 6 to be driven generated thereby.

The piezoelectric actuators of the inertia motor according to the invention are controlled in four time periods with two electrical alternating voltages U1, U2 of the same amplitude but different polarity. While in the first time period within the time t1 the voltage U1 of the generator 17 increases linearly up to the maximum value U1max with a slope Kup (ramp function), the voltage U2 of the generator 18 has an identical but negative slope or slope −Kup, i.e. it falls to the negative maximum value −U2max. In the second time period, i.e. within the time t2, the amplitudes of the two voltages U1, U2 remain unchanged. The voltage U1 then drops with the slope −Kdw within the time t3 and the voltage U2 increases with Kdw. Within time t4, the amplitude of the voltages LH, U2 is zero. The frequency fexc of the alternating voltages LH, U2 is the same and amounts to several tens of kHz. The rise time t1 is significantly shorter than the fall time t3.

FIG. 14a) to 14d) show maximum deformations of the drive device according to FIGS. 2, 5, 6 and 8 calculated using FEM when the actuators are controlled for generating a drive movement of an element to be driven in or counterclockwise. Included 14a) shows the corresponding deformations in a drive device 2 according to FIG. 2, FIG. 14b) the corresponding deformations in a drive device 2 according to FIG. 14d) the corresponding deformations in a drive device according to FIG. 8.

The piezoelectric inertia drive 1 according to the invention and its excitation device 16 have the following mode of operation: the generators 17, 18 of the excitation device 16 generate two sawtooth-like electrical voltages U1, U2 with the same time profile, the same amount of voltage and a different polarity (see FIG. 13) . The time course of the electrical voltages U1, U2 has two areas t1, t3 with a different slope. In the first area t1 the gradient is small. In this area, the magnitude of the voltages U1, U2 increases slowly up to their final value U1max, U2max. In the second area with a large slope t3, the magnitude of the voltage U1, U2 decreases very quickly. The difference is preferably an order of magnitude. Furthermore, in the time course of the voltages U1, U2 there can be two further areas t2, t4 in which the amounts of the voltages U1, U2 remain unchanged.

To excite the piezoelectric inertia drive 1, the voltages U1, U2 are applied to each piezoelectric actuator 11 at time t=0 (see FIG. 12b). The actuator supplied with positive electrical voltage U1 then slowly expands, while the actuator supplied with negative voltage U2 contracts. Due to the expansion or contraction of the actuators, the drive element 5 of the drive device 2 connected to them experiences a deformation shown in FIG. 14. The inner circumferential surfaces 4 of the drive element 5, which are in thread friction engagement with the element 6 to be driven, give it a rotation due to the static friction force prevailing between them. The direction of rotation depends on the polarity of the voltages U1, U2 or the direction of deformation of the actuators and is marked by arrows in FIG. 13a).

After the phase of the small slope t1, the phase t2 can take place, in which the actuator voltages remain unchanged and the element 6 to be driven comes to rest. In the subsequent phase of the large slope t3, the amounts of the voltages U1, U2 decrease very quickly. The actuators follow the electrical voltages and change their direction of deformation at the same time. This means that the previously expanded actuator contracts and the contracted one expands. Since the element to be driven has mass, it cannot follow the actuator movement or the movement of the drive element due to inertia and remains in its position. Due to the forces occurring in the frictional contact, the static friction changes into sliding friction. The surfaces of the friction contact between the drive element and the element to be driven slide against each other. This is followed by phase t4, in which the electrical voltages U1, U2 are zero and in which the element to be driven is at rest. The sequence of movements repeats periodically with a frequency of a maximum of a few kHz. The element to be driven is set directly into a rotational movement and indirectly into a rectilinear movement. To reverse the direction of movement of the element to be driven, the voltages U1, U2 are swapped.

### LIST OF REFERENCE SYMBOLS

1 Piezoelectric inertia sensor
2 drive device
3 threads (the inner peripheral surface 4)
4 inner circumferential surface
5, 15 drive element
6 element to be driven
7 threads (of the element to be driven 6)
8 outer peripheral surface (of the element to be driven 6)
9, 10 contact element (of the drive element 5)
11 multi-layer piezoelectric actuator
12, 13 pages (of the multi-layer piezoelectric actuator 11)
14 base element
16 excitation device
17, 18 generators of electrical voltage
19 virtual longitudinal axis
20 elastic element
21 electrical connections of the actuator
22 spring hole
23 mounting hole
24 mounting hole of an elastic element
25 glue bags
26 piezoelectric layer (of the actuator 11)
27, 28 elastic element
29 connecting element
30 elastic element
31 movable element
32, 33, 34 elastic element
35 supports (of the base element 14)
36 connecting element
37 elastic element
38 threaded rod
39 element to be driven in the form of a monolithic rod
40 Hollow thread rod
41 Axial opening in the element to be driven
42 Sound-absorbing rod
43 Layer of sound-absorbing material
44 elastic element,
45, 46 mounting holes
47 Phase accumulator (PA)
48 Pulse width or pulse density modulator (PWM or PDM)
49 switched power output stage (SPS)
50 Low pass filter (LP)
51 Current sensor (CS)
52 Current control unit (CCU)

1-31. (canceled)

32. A piezoelectric inertial drive comprising a drive device with a drive element comprising contact elements with an inner circumferential surface comprising a thread, an element to be driven comprising an outer circumferential surface with a thread, and an electrical excitation device for electrically driving the drive device, wherein the element to be driven is in threaded engagement with the drive elements, and the contact elements are arranged symmetrically with respect to a virtual diametrical parting plane and at least partially surround the element to be driven, wherein the contact elements are connected directly or indirectly to a base element and to one another, and the drive device comprises at least two multilayer piezoelectric actuators with a virtual actuator longitudinal axis, which are arranged with a respective first side on the base element and with a respective other side opposite the first side on the respective contact element, and the electrical excitation device includes at least two generators which provide electrical voltages for exciting the piezoelectric actuators, characterized in in that the contact elements of the drive element are connected to one another via an elastic element and are connected, by means of connecting elements, to two or four elastic elements of supports of the base element, wherein the piezoelectric actuators are prestressed by the elastic elements in the axial direction by means of the connecting elements (36).

33. The piezoelectric inertial drive according to claim 32, characterized in that each virtual actuator longitudinal axis is arranged parallel to the virtual diametral plane.

34. The piezoelectric inertia drive according to claim 32, characterized in that the same comprises elastic elements which are connected to the base element and by means of which the contact elements are pressed against the element (6) to be driven.

35. The piezoelectric inertial drive according to claim 32, characterized in that the drive device comprises an elastic element by means of which the contact elements are pressed against the element to be driven.

36. The piezoelectric inertial drive according to claim 32, characterized in that the base element comprises two movable elements and two elastic elements by means of which the contact elements are pressed against the element to be driven.

37. The piezoelectric inertial drive according to claim 32, characterized in that the drive element comprises an elastic element by means of which the corresponding piezoelectric actuator is pre-stressed in the axial direction.

38. The piezoelectric inertial drive according to claim 37, characterized in that the drive element comprises a connecting element by means of which the corresponding piezoelectric actuator is pre-stressed in cooperation with the elastic element.

39. A piezoelectric inertial drive comprising a drive device with a drive element which comprises contact elements comprising an inner peripheral surface provided with a thread, an element to be driven comprising an outer peripheral surface provided with a thread, and an electrical excitation device for electrically driving the drive device, wherein the element to be driven is in threaded engagement with the drive elements, and the contact elements are arranged symmetrically with respect to a virtual diametrical parting plane and at least partially engage around the element to be driven, wherein the contact elements are connected directly or indirectly to a base element, and the drive device comprises at least two multi-layer piezoelectric actuators with a virtual actuator longitudinal axis, which are arranged with a respective first side on the base element and with a respective other side opposite the first side on the respective contact element, and wherein the electrical excitation device comprises at least two generators, which provide electrical voltages for exciting the piezoelectric actuators, characterized in that the drive element is designed as a two-part element and is connected by means of connecting elements to two or four elastic elements of supports of the base element, and in that the piezoelectric actuators are pre-stressed in the axial direction by the elastic elements by means of the connecting elements.

40. The piezoelectric inertia drive according to claim 39, characterized in that the element to be driven is designed as a hollow threaded rod and the corresponding cavity is filled with a sound-absorbing material.

41. The piezoelectric inertia drive according to claim 39, characterized in that the thread of the element to be driven or the thread of the contact elements is made of an abrasion-resistant material or is provided with an abrasion-resistant layer.

42. The piezoelectric inertia drive according to claim 39, characterized in that the same comprises a pressing device with which the element to be driven is pressed against the drive element and which acts directly or indirectly on the element to be driven in the axial direction.

43. The piezoelectric inertial drive according to claim 39, characterized in that the same comprises two or more drive device which act on a common element to be driven, the drive devices being fixed relative to one another by elastic elements.

44. The piezoelectric inertial actuator according to claim 39, characterized in that the electrical excitation device is designed to generate two complementary sawtooth-shaped electrical voltages U1, U2 in order to excite the piezoelectric actuators.

45. The piezoelectric inertia drive according to claim 32, characterized in that the element to be driven is designed as a hollow threaded rod and the corresponding cavity is filled with a sound-absorbing material.

46. The piezoelectric inertia drive according to claim 32, characterized in that the thread of the element to be driven or the thread of the contact elements is made of an abrasion-resistant material or is provided with an abrasion-resistant layer.

47. The piezoelectric inertia drive according to claim 32, characterized in that the same comprises a pressing device with which the element to be driven is pressed against the drive element and which acts directly or indirectly on the element to be driven in the axial direction.

48. The piezoelectric inertial drive according to claim 32, characterized in that the same comprises two or more drive device which act on a common element to be driven, the drive devices being fixed relative to one another by elastic elements.

49. The piezoelectric inertial actuator according to claim 32, characterized in that the electrical excitation device is designed to generate two complementary sawtooth-shaped electrical voltages U1, U2 in order to excite the piezoelectric actuators.
